(19) United States
(12) Patent Application Publication
(10) Pub. No.: US 2025/0078842 A1
(43) Pub. Date: Mar. 6, 2025

(54) MULTI-SPEAKER SPEECH RECOGNITION FACILITATED BY LANGUAGE MODELS

(71) Applicant: NVIDIA Corporation, Santa Clara, CA (US)

(72) Inventors: Taejin Park, San Jose, CA (US); Kunal Dhawan, San Jose, CA (US); Nithin Rao Koluguri, Milpitas, CA (US); Jagadeesh Balam, Campbell, CA (US)

(21) Appl. No.: 18/401,936

(22) Filed: Jan. 2, 2024

Related U.S. Application Data
(60) Provisional application No. 63/535,417, filed on Aug. 30, 2023.

(51) Int. Cl. G10L 17/06; G10L 17/02

(52) U.S. Cl. CPC G10L 17/06; G10L 17/02

(57) ABSTRACT

Disclosed are apparatuses, systems, and techniques that leverage one or more language models (LMs)—such as large language models (LLMs—for efficient multi-speaker speech recognition. The techniques include processing, using a speaker diarization model, an audio feature to generate a first association of the audio feature with one or more prospective speakers, the audio feature being representative of one or more spoken words. The techniques further include providing, to an LM, a first prompt requesting the LM to identify a second association of the one or more spoken words with the one or more prospective speakers and receiving, from the LM, a first response identifying the second association of the one or more spoken words with the one or more prospective speakers. The techniques further include determining, using the first association and the second association, one or more speakers that produced the one or more spoken words.

### RELATED APPLICATIONS

This application claims the benefit of U.S. Provisional Patent Application No. 63/535,417, filed Aug. 30, 2023, entitled “Speaker Diarization Using LLMs in Conversational AI Systems and Applications,” the contents of which are incorporated by reference in their entirety herein.

### TECHNICAL FIELD

At least one embodiment pertains to processing resources used to perform and facilitate various speaker identification, verification, and/or diarization tasks. For example, at least one embodiment pertains to the use of machine learning techniques in speaker diarization.

### BACKGROUND

Speaker identification involves associating a spoken utterance with other utterances (or some representation of those utterances) stored in a database of speakers, identifying a specific speaker who produced the spoken utterance, and/or determining that the spoken utterance was produced by a new speaker not represented in the database. Speaker verification involves determining whether two or more utterances are spoken by the same speaker or different speakers, regardless of whether the speech processing system has encountered these speakers previously. Speaker diarization involves partitioning unstructured speech episodes involving multiple speakers (e.g., a conversation, a meeting, a public event, etc.) into time-stamped utterances produced by various specific speakers (known or unknown). Speaker diarization can be performed in conjunction with speaker verification or identification, e.g., when the speakers participating in a speech episode are represented in the database of speakers. As another example, speaker diarization may be performed independently from speaker verification or identification, e.g., when one or more of the speakers cannot be recognized. Modern speaker identification, verification, and/or diarization systems often deploy trained neural network models.

### BRIEF DESCRIPTION OF DRAWINGS

FIG. 1 is a block diagram of an example computer system capable of supporting multi-speaker speech recognition assisted by one or more language models, in accordance with at least some embodiments;

FIG. 2 illustrates an example computing device that supports training or deployment of a multi-speaker speech recognition system that deploys one or more language models, according to at least one embodiment;

FIG. 3A illustrates an architecture and data flow in an example multi-speaker speech recognition system that uses a language model, according to at least one embodiment;

FIG. 3B illustrates operations of automatic speech recognition component of multi-speaker speech recognition system, according to at least one embodiment;

FIG. 4 illustrates example operations of a speaker search decoder deployed as part of the multi-speaker speech recognition system of FIG. 3A, according to at least one embodiment;

FIG. 5 is a flow diagram of an example method of efficient multi-speaker speech recognition assisted by one or more language models, according to at least one embodiment;

FIG. 6A is a flow diagram of an example method of performing a speaker search in the context of multi-speaker speech recognition assisted by one or more language models, according to at least one embodiment;

FIG. 6B is a flow diagram of an example method of identifying spoken words in the context of multi-speaker speech recognition assisted by one or more language models, according to at least one embodiment

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 is an example data flow diagram for an advanced computing pipeline, according to at least one embodiment; and

FIG. 10 is a system diagram for an example system for training, adapting, instantiating and deploying machine learning models in an advanced computing pipeline, according to at least one embodiment.

### DETAILED DESCRIPTION

Multi-speaker speech recognition combines speaker diarization (SD) which maps various portions A₁, A₂, etc., of a given audio data to respective speakers S₁, S₂, etc. with automatic speech recognition (ASR)—which converts the audio portions A₁, A₂, etc., into spoken words W₁, W₂, etc. Conventional multi-speaker speech recognition typically deploys two branches of processing. The SD branch identifies most likely speakers S*(whose number may be apriori unknown) responsible for uttering words captured by various audio portions A. The SD branch can deploy an acoustic model trained to identify various speech characteristics (features) of individual speakers, e.g., tone, timbre, cadence, volume, and/or the like, and obtain audio-to-speaker mapping A↔S*. An ASR branch identifies most likely words W* captured by the audio portions A. The ASR branch can also deploy an acoustic model (which can be different from the acoustic model of the SD branch) trained to identify pronunciation of different words, e.g., based on phonemes, pauses, and/or other acoustic content of speech and obtain audio-to-word mapping A↔W*. To improve accuracy of the audio-to-word mapping, the ASR processing branch can be further augmented with a language model trained to capture lexical context of speech and identify logical connections between units (words, phrases, etc.) of the speech. For example, the language model can be trained to predict the next word in a word or phrase, determine whether two adjacent words/phrases are related (by context) or unrelated, and/or the like. The language model can process embeddings representative of the audio portions A (e.g., received from the acoustic model) and provide additional contextual (lexical) information that is used together with the output of the acoustic model to obtain audio-to-word mapping A↔W*. For example, where the acoustic model alone may have difficulty distinguishing “language model” from “Long Beach modem,” the context gleaned from preceding words can identify the first phrase as more likely to be correct compared with the second phrase, resulting in reduced frequency of misidentified words.

Performance of a machine learning model is predicated, at least in part, on the amount and quality of training data available for training of the model. To achieve high inference accuracy, a model should be trained with diverse sets of training data that include not only typical examples but also less frequent but more difficult cases. Training data for language models includes many readily available texts in a practically unlimited number of different fields. Actual texts provide both training inputs (e.g., unfinished phrases) and target outputs (missing or subsequent words) that can be used for self-supervised training of language models. Training data for acoustic models, on the other hand, is much more difficult to generate and often requires manual annotations/transcriptions, speaker consent, and/or the like. Because diverse acoustic model training can be expensive and difficult to accomplish, obtaining highly accurate acoustic models can be problematic. This, in turn, makes multi-speaker diarization challenging, in particular, adversely affecting accuracy of the SD processing branch.

Aspects and embodiments of the present disclosure address these and other technological challenges by providing for techniques and systems that improve performance of multi-speaker speech recognition systems by augmenting acoustic speaker diarization processing with deployment of language models. More specifically, the SD processing branch may include both an acoustic model and a language model (LM), e.g., a large language model (LLM). SD processing may include receiving portions A₁, A₂, etc. of audio data and identifying a likelihood that one of speakers S₁, S₂, etc. (e.g., speakers who previously uttered one or more words/phrases or a new speaker) has spoken a respective audio portion Aⱼ. The ASR processing branch may likewise process the audio portions A₁, A₂, etc., to determine one or more spoken words W₁, W₂, etc., captured by the audio portions. The spoken words W₁, W₂, etc., and the set of speakers S₁, S₂, etc., may be used to form one or more prompts to the LM. For example, a first prompt may inform the LM about a set of previously identified words {Wₚ} and ask the LM to estimate likelihoods of various possible words W that follow this set {Wₚ}: P(W|{Wₚ}). A second prompt may inform the LM about the most likely word W (or several most likely words) and ask the LM to estimate likelihoods that various previously identified speakers S₁, S₂, etc. (or a new speaker) have spoken the word W (or several words): P(S|W). The likelihoods estimated by the LM may be used, e.g., together with the output of the SD model, by a speaker decoder (e.g., a beam-search decoder or some other search decoder) to determine the mapping of the audio portion(s) to the most likely speaker(s): A↔S*. The audio-to-speaker mapping may then be combined with the output of the ASR processing branch, e.g., mapping of the audio portions to the most likely word, A↔W*, to identify accurate mapping of word(s) to speaker(s) W* ↔S* for various portions of the speech. Numerous other embodiments that implement accurate multi-speaker diarization systems are disclosed herein.

The advantages of the disclosed techniques include but are not limited to enhanced accuracy of association of portions of speech with correct speakers, facilitated by the combined use of the acoustic model and the LM in the speaker diarization processing. The augmentation of diarization processing with information generated by the LM reduces the need for acoustic diarization models to learn lexical context of speech. As a result, training of acoustic diarization models may be focused on identification of audio characteristics of speech, instead of attempting to capture both the audio characteristics and lexical content at once. Additionally, the disclosed systems and techniques may have a variable (and apriori unknown) number of speakers since this number is not limited by an output dimension of any fixed-size neural network model. Furthermore, the disclosed systems and techniques may be more universally deployed in different languages, where language-specific LMs (trained to capture lexical contexts) can be swapped when the system is re-formatted for use with a different language. On the other hand, the acoustic diarization model, being trained to focus on more universal audio characteristics of speech, may remain the same.

### System Architecture

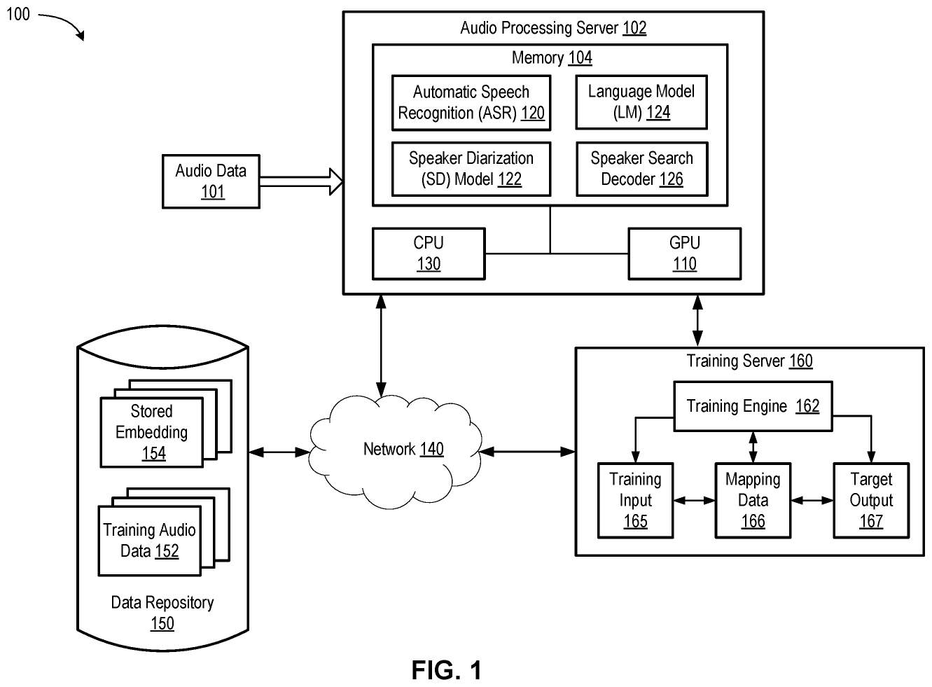

FIG. 1 is a block diagram of an example computer system 100 capable of supporting multi-speaker speech recognition assisted by one or more language models, in accordance with at least some embodiments. As depicted in FIG. 1, a computer system 100 may include an audio processing server 102, a data repository 150, and a training server 160 connected to a network 140. Network 140 may be a public network (e.g., the Internet), a private network (e.g., a local area network (LAN), or wide area network (WAN)), a wireless network, a personal area network (PAN), a combination thereof, and/or another network type.

Audio processing server 102 may include a desktop computer, a laptop computer, a smartphone, a tablet computer, a server, a wearable device, a VR/AR/MR headset or head-up display, a digital avatar or chatbot kiosk, an in-vehicle infotainment computing device, and/or any suitable computing device capable of performing the techniques described herein. Audio processing server 102 may be configured to receive audio data 101 that may be associated with any speech episode involving one or more speakers. Speech episodes may include a public or private conversation, a business meeting, a public or private presentation, an artistic event, a debate, an interaction between a digital agent (e.g., chatbot, digital avatar, etc.) and one or more users, an in-vehicle communication (e.g., between two or more occupants, between an occupant(s) and a chat bot, avatar, or digital assistant of the vehicle), and/or the like. Audio data 101 may be recorded using one or more devices connected to audio processing server 102, retrieved from memory 104 of audio processing server 102, and/or received over any local or network connection (e.g., via network 140) from an external computing device. Audio data 101 may be in any suitable format, e.g., WAV, AIFF, MP3, AAC, WMA, or any other compressed or uncompressed audio format. In some embodiments, audio data 101 may be stored (e.g., together with other data, such as metadata) in data repository 150. Additionally, data repository 150 may store training audio data 152 for training one or more models capable of speaker identification, speaker verification, and/or speaker diarization, according to some embodiments disclosed herein. Data repository 150 may be accessed by audio processing server 102 directly or (as shown in FIG. 1) via network 140.

Data repository 150 may include a persistent storage capable of storing audio files as well as metadata for the stored audio files. Data repository 150 may be hosted by one or more storage devices, such as main memory, magnetic or optical storage disks, tapes, or hard drives, network-attached storage (NAS), storage area network (SAN), and so forth. Although depicted as separate from audio processing server 102, in at least some embodiments, data repository 150 may be a part of audio processing server 102. In at least some embodiments, data repository 150 may be a network-attached file server, while in other embodiments, data repository 150 may be some other type of persistent storage such as an object-oriented database, a relational database, and so forth, that may be hosted by a server machine or one or more different machines coupled to the audio processing server 102 via network 140.

Audio processing server 102 may include a memory 104 (e.g., one or more memory devices or units) communicatively coupled with one or more processing devices, such as one or more graphics processing units (GPU) 110, one or more central processing units (CPU) 130, one or more data processing units (DPU), one or more parallel processing units (PPUs), and/or other processing devices (e.g., field-programmable gate arrays (FPGAs), application-specific integrated circuits (ASICs), and/or the like). Memory 104 may store one or more components and models, such as automatic speech recognition 120 component that may include one or multiple models trained and configured to recognize spoken words in audio data 101. Memory 104 may further include a speaker diarization (SD) model 122 to determine likelihoods that various portions of audio data are uttered by different speakers. Memory 104 may further include a language model (LM) 124, e.g., a large language model (e.g., a model having hundreds of millions or billions of learned parameters). LM 124 may provide additional lexical information for increased accuracy of speaker diarization, e.g., responses of LM 124 to various prompts. Such prompts can cause LM 124 to identify likelihoods that specific words are to follow a known set of previously identified words, likelihoods that given speakers have uttered various known (or hypothesized) words based on the context of the speech, and/or the like. Memory 104 may further include a speaker search decoder 126 that identifies the most likely speaker that produced a given word (or a set of words) identified by ASR 120. Speaker search decoder 126 may use outputs of SD model 122 and LM 124 and may include a depth-first search, a breadth-first search, a beam search, and/or the like.

In at least one embodiment, models used by ASR 120 component, SD model 122, LM 124, and/or other deployed models may be implemented as deep learning neural networks having multiple levels of linear and/or non-linear operations. For example, each or some of the deployed models may include convolutional neural networks, recurrent neural networks, fully-connected neural networks, long short-term memory (LSTM) neural networks, neural networks with attention, e.g., transformer neural networks, and/or the like. In at least one embodiment, any, some, or all deployed models may include multiple neurons, with an individual neuron receiving its input from other neurons and/or from an external source and producing an output by applying an activation function to the sum of (trainable) weighted inputs and, in some neurons, a bias value. In at least one embodiment, one or more of the deployed models may include multiple neurons arranged in layers, including an input layer, one or more hidden layers, and/or an output layer. Neurons from adjacent layers may be connected by weighted edges. In some embodiments, training server 160 may train a number of different models, which may be models that differ by a number of neurons, number of neuron layers, activation functions, specific neural architecture, and/or the like.

Training server 160 may use training audio data 152 to train one or more models, e.g., to identify parameters (neural weights, biases, parameters of activation functions, etc.) of the models in a way that maximizes success of speech recognition, speech diarization, and/or various other speech-related tasks, e.g., speaker identification, speaker verification, and/or the like. Training server 160 may be hosted by a desktop computer, a laptop computer, a smartphone, a tablet computer, a server, and/or any suitable computing device capable of performing the techniques described herein. In some embodiments, training of models used by ASR 120 component, SD model 122, and/or other deployed models may be supervised, e.g., using human annotations of training audio data 152. Such annotations can include ground truth transcripts of recorded speech, labels identifying speakers in multi-speaker audio recordings, and/or the like. Training audio data 152 or may be used for supervised training, unsupervised training, semi-supervised training, training that includes reinforcement learning techniques, and/or other types of training.

Training audio data 152 may be used by training engine 162 as training input 165 to train one or more models used by ASR 120 component to recognize spoken words in the training audio data 152. Training engine 162 may also train SD model 122 to associate specific portions (e.g., 0.05-5 sec portions) of training audio data 152 with various speakers, e.g., assigning unique labels to such portions, e.g., “Speaker 1,” “Speaker 2,” etc. The actual identity of speakers (unless included as part of training audio data 152) need not be known. In some embodiments, e.g., in the instances where one or more speaker identification (or speaker verification) models are being trained, more specific identification of speakers may be performed. For example, training audio data 152 for training of a speaker identification model may include a database of stored voice samples of multiple people and the model may be trained to identify a correct speaker from the database. In some embodiments, training engine 162 may use training embeddings (e.g., stored embeddings 154) representative of segments of training audio data 152. During training, training engine 162 may also generate mapping data 166 (e.g., metadata) that associates training inputs 165 with correct target outputs 167 (ground truth). During training, training engine 162 may identify patterns in training inputs 165 based on desired target outputs 167 and cause ASR 120 to learn how to accurately recognize spoken words in the training audio data 152 and also cause SD model 122 to learn how to associate portions of training audio data 152 with various speakers.

Training audio data 152 may be stored in a data repository 150 in a raw audio format, e.g., in the form of spectrograms, or in any other suitable representation characterizing speech (e.g., of a particular person). For example, a spectrogram of training audio data 152 may be obtained by recording air pressure caused by the speech as a function of time and computing a short-time Fourier transform for overlapping time intervals (frames) of a set duration. This maps the audio signal from the time domain to the frequency domain and generates a spectrogram characterizing the spectral content of training audio data 152. The amplitude of the audio signal may be represented on a logarithmic (decibel) scale. In some embodiments, the obtained spectrograms may be further converted into mel-spectrograms, by transforming frequency f into a non-linear mel domain, f→m=a ln(1+f/b), to take into account the ability of a human ear to better distinguish between equally spaced frequencies (tones) at the lower end of the frequencies of the audible spectrum than at its higher end. In one example, a=1607 and b=700 Hz. Throughout this disclosure, the term “speech spectrogram” may be understood to include Fourier spectrograms or mel-spectrograms, where applicable.

Initially, edge weights and biases of various network models being trained may be assigned some starting (e.g., random) values. For various training inputs 165, training engine 162 may cause one or more of ASR 120 and/or SD model 122 to generate training output(s). Training engine 162 may then compare observed training output(s) with the desired target output(s) 167. The resulting error or mismatch, e.g., the difference between the desired target output(s) 167 and the training output(s), may be backpropagated through the respective neural networks, and the parameters (e.g., weights and biases) of the neural networks may be adjusted to make the training outputs closer to the target (ground truth) outputs 167. This adjustment may be repeated until the output error for a given training input 165 satisfies a predetermined condition (e.g., falls below a predetermined value). Subsequently, a different training input 165 may be selected, a new output generated, and a new series of adjustments implemented, until the respective neural networks are trained to a target degree of accuracy or until the neural network(s) converges to a limit of its accuracy.

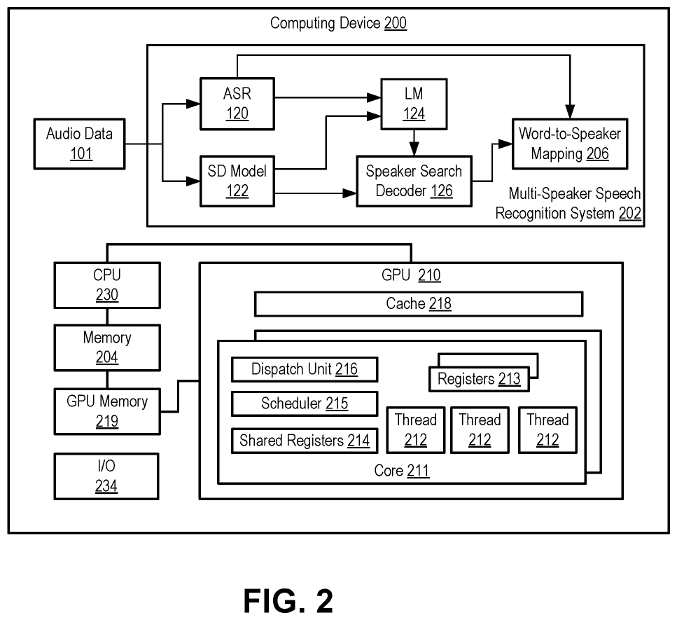

In some embodiments, LM 124 (and/or other language models that may be used by multi-speaker speech recognition system 202 of FIG. 2) may also be trained by training engine 162. In some embodiments, LM 124 may be a model that is trained and deployed by an external (to audio processing server 102) service, e.g., a cloud service. In some embodiments, LM 124 (and/or other deployed language models) may be or include a large language model. LM 124 may be trained to capture syntax and semantics of human language, e.g., by predicting a next, a previous, and/or a missing word in a sequence of words (e.g., one or more sentences of a human speech or text). LM 124 may be further trained using training data containing a large number of texts, such as human dialogues, newspaper texts, magazine texts, book texts, web-based texts, and/or any other texts. Trained LM 124 may be capable of carrying out a conversation with a user (a human user or a computer) in natural language in a manner that closely resembles a dialogue with a human speaker, including understanding the user's intent and responding in ways that the user expects from a conversational partner. LM 124 may be implemented using neural networks with a large number (billions) of artificial neurons, e.g., deep learning neural networks with a self-attention mechanism (such as transformer neural networks).

Predictive utility of the patterns identified by the trained models may be subsequently verified (validated or tested) using additional training input/target output associations. The trained models, e.g., one or more models used by ASR 120, SD model 122, LM 124, and/or other deployed models similarly trained, may subsequently be used, during the inference stage, for processing of new (not encountered previously) input speech.

In at least one embodiment, training server 160 and audio processing server 102 may be implemented on a single computing device. Training server 160 and/or audio processing server 102 may be (and/or include) a rackmount server, a router computer, a personal computer, a laptop computer, a tablet computer, a desktop computer, a media center, or any combination thereof.

FIG. 2 illustrates an example computing device 200 that supports training or deployment of a multi-speaker speech recognition system that deploys one or more language models, according to at least one embodiment. In at least one embodiment, computing device 200 may be a part of audio processing server 102. In at least one embodiment, computing device 200 may be a part of training server 160. In at least one embodiment, computing device 200 supports a multi-speaker speech recognition system 202 that includes (but need not be limited to) ASR 120, speaker diarization model 122, language model 124, and speaker search decoder 126. Multi-speaker speech recognition system 202 may be capable of processing audio data 101 and generating accurate word-to-speaker mapping 206 for audio data 101, including accurate transcription of words captured by audio data 101 and accurate speaker labels indicating a correct speaker for various individual words, phrases, sentences, and/or various other components of multi-speaker speech. Operations of multi-speaker speech recognition system 202 may be executed using one or more GPUs 210, one or more CPUs 230, one or more parallel processing units (PPUs) or accelerators, such as a deep learning accelerator, data processing units (DPUs), and/or the like. In at least one embodiment, a GPU 210 includes multiple cores 211, each core being capable of executing multiple threads 212. Each core may run multiple threads 212 concurrently (e.g., in parallel). In at least one embodiment, threads 212 may have access to registers 213. Registers 213 may be thread-specific registers with access to a register restricted to a respective thread. Additionally, shared registers 214 may be accessed by one or more (e.g., all) threads of the core. In at least one embodiment, each core 211 may include a scheduler 215 to distribute computational tasks and processes among different threads 212 of core 211. A dispatch unit 216 may implement scheduled tasks on appropriate threads using correct private registers 213 and shared registers 214. Computing device 200 may include input/output component(s) 234 to facilitate exchange of information with one or more users or developers.

In at least one embodiment, GPU 210 may have a (high-speed) cache 218, access to which may be shared by multiple cores 211. Furthermore, computing device 200 may include a GPU memory 219 where GPU 210 may store intermediate and/or final results (outputs) of various computations performed by GPU 210. After completion of a particular task, GPU 210 (or CPU 230) may move the output to (main) memory 204. In at least one embodiment, CPU 230 may execute processes that involve serial computational tasks whereas GPU 210 may execute tasks (such as multiplication of inputs of a neural node by weights and adding biases) that are amenable to parallel processing. In at least one embodiment, multi-speaker speech recognition system 202 may determine which processes are to be executed on GPU 210 and which processes are to be executed on CPU 230. In other embodiments, CPU 230 may determine which processes are to be executed on GPU 210 and which processes are to be executed on CPU 230.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems for generating or presenting at least one of augmented reality content, virtual reality content, mixed reality content, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implementing one or more language models, such as large language models (LLMs) (which may process text, voice, image, and/or other data types to generate outputs in one or more formats), systems implemented at least partially using cloud computing resources, and/or other types of systems.

### Multi-Speaker Speech Recognition System

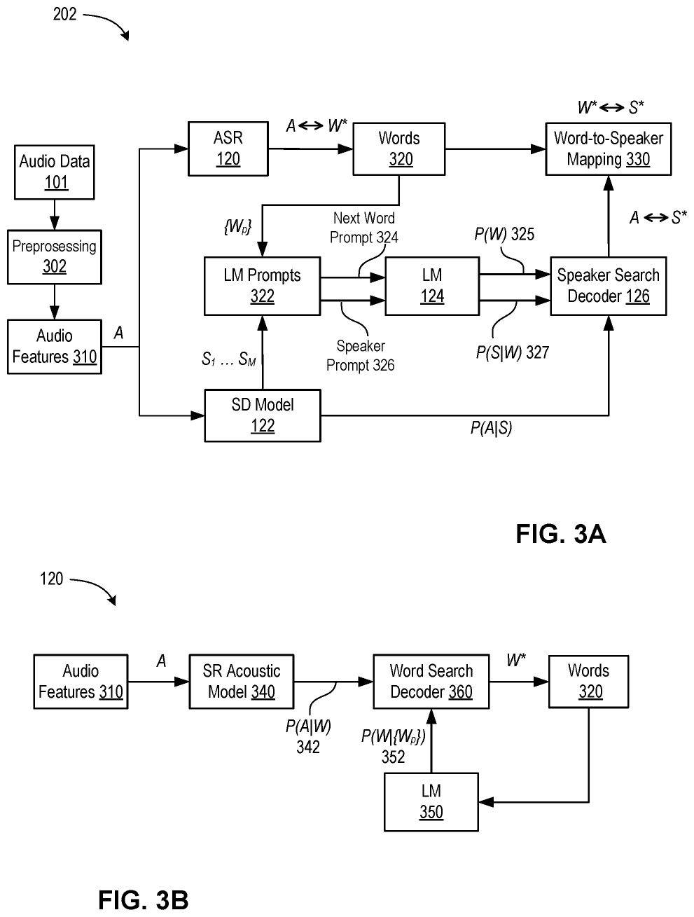

FIG. 3A illustrates an architecture and data flow in an example multi-speaker speech recognition system 202 that uses one or more language models, according to at least one embodiment. In at least one embodiment, multi-speaker speech recognition system 202 may be implemented as part of audio processing server 102, which may be located on a single computing device or on multiple computing devices. Various blocks in FIG. 3A denoted with the same numerals as the respective blocks of FIG. 1 and/or FIG. 2 may implement the same (or a similar) functionality.

Multi-speaker speech recognition system 202 of FIG. 3A may receive audio data 101 captured by one or more audio sensors, e.g., microphones. Microphones can include dynamic microphones, condenser microphones, ribbon microphones, unidirectional microphones, omnidirectional microphones, and/or any other types of microphones. In some embodiments, a microphone can be combined with other devices, e.g., computers, phones, speakers, TV screens, and/or the like. The audio data 101 collected by the audio sensors may be generated, e.g., spoken, by any number of speakers and may include a single speech episode or multiple speech episodes. The audio sensors may capture not only a speech signal but also background noise, interference signals, e.g., emitted by TV devices, radio devices, alarm devices, and/or any other equipment, or sounds naturally occurring (e.g., sound of wind, water, birds, etc.). In some embodiments, audio data 101 may retrieved from memory (e.g., memory 104 of audio processing server 102 in FIG. 1 and FIG. 2), and/or received over any local or network connection (e.g., via network 140 in FIG. 1 and FIG. 2) from an external computing device or memory.

Audio data 101 may undergo a suitable preprocessing 302. For example, preprocessing 302 may include audio filtering, denoising, amplification, dereverberation, segmentation, and/or any other audio enhancement. Preprocessing 302 may further include removal of portions of the audio data 101 that do not have a speech content. For example, preprocessing 302 may evaluate energy e(t) associated with the audio data as a function of time and identify regions that have energy less than a certain threshold (e.g., an empirically determined noise threshold). Such identified regions may be removed (trimmed) from the audio data 101 during speech preprocessing. Segmentation may include segmenting the audio data 101 into intervals of a predetermined sizes (durations), τ, e.g., 0.05-5 sec. Such intervals are sometimes referred to as utterances herein. It should be understood that the utterances need not correspond to a complete logical unit of speech and may encompass one or more sentences, one or more words, a part of a word, one or more exclamations, filler words, pauses, and/or the like. In some embodiments, the utterances (intervals) may be partially overlapping.

Individual utterances may be represented by a plurality of frames, e.g., T frames over a certain predetermined interval of time. Frames may have a duration of 15 msec, 20 msec, 30 msec, and/or some other duration. Frames may undergo a suitable frame-to-spectrogram transformation. For example, a spectrogram of a frame may be obtained or generated by performing a discrete Fourier transform of acoustic energy e(t) or air pressure p(t) associated with a specific utterance. The obtained spectrograms e(fⱼ) may be defined for a number of bands f₁, f₂ . . . f_{C}, for example, for C=80 bands or C=128 bands, or any other number of bands. In some embodiments, the bands may be mel-bands and the spectrograms may be mel-spectrograms. Separate spectrograms may be obtained for separate audio frames.

The preprocessed audio data 101 can first be converted into audio features 310, also referred to as embeddings (denoted A), e.g., using wav2vec converter or any other suitable audio-to-embedding converter. An embedding (audio feature) should be understood as any suitable digital representation of audio data 101, e.g., as a vector (string) of any number D of components, which can have integer values or floating-point values. Embeddings can be considered as vectors or points in a D-dimensional embedding space. The dimensionality D of the embedding space can be smaller than the size of the audio data 101 (or corresponding spectrograms or frames representing audio data 101). Audio features 310 can be generated using a suitable embeddings model that is trained to associate similar sets of training audio spectrograms/frames, with similar embeddings represented by points closely situated in the embedding space and dissimilar sets of training audio spectrograms/frames represented by points that are located farther apart in the embedding space. In some embodiments, a separate embedding (or a separate set of embeddings) can represent a given audio spectrogram/frame or a set of a predetermined number of audio spectrograms/frames.

A given audio feature (embedding) A is to be understood as any set of one or more embeddings that are concurrently evaluated by one or more processing components, e.g., ASR 120, SD model 122, and/or the like. Audio feature A can encode one or more words or a portion of a word (e.g., one or more syllables of a word). For the sake of simplicity and convenience of illustration but not limitations, it will often be presumed below that an individual feature A encodes acoustic and lexical information of a portion of audio data 101 that corresponds to one word.

As disclosed in more detail below in conjunction with FIG. 3B, audio feature A may be processed by ASR 120 that identifies the most likely spoken word W* represented by audio feature A, referred to as audio-to-word mapping herein: A↔W*. A time-ordered sequence of such words 320 is then used in word-to-speaker mapping 330 that maps the most likely spoken words W* to the most likely speakers S*: W* ↔S*. Additionally, the sequence of the most likely spoken words 320 may be used to prepare inputs into LM 124, as disclosed in more detail below.

Audio feature A may also be used as an input into SD model 122. SD model 122, LM 124, and speaker search decoder 126 represent a speaker diarization branch of multi-speaker speech recognition system 202. The speaker diarization branch outputs the most likely speaker S* represented by audio feature A, referred to as (time-stamped) audio-to-speaker mapping herein: A↔S*. The audio-to-word mapping A↔W*and the audio-to-speaker mapping A ↔S* may then be used to determine word-to-speaker mapping W* ↔S* (330).

In some embodiments, the speaker diarization branch implements a Bayes-like classifier that predicts a conditional probability P(S|A, W; {Wₚ}) that a particular speaker S uttered word W captured by audio feature A following a series of one or more preceding words {Wₚ}=W₁ . . . W_{N} (“probability of S given A and W”). According to the Bayesian framework, the conditional probability P(S|A, W; {Wₚ}) may be expressed via the conditional probability P(A, W|S; {Wₚ}) (“probability of A and W given S”),

$$P ( S \vert A , W ; \{ {W}_{p} \} ) = \frac{P ( A , W \vert S ; \{ {W}_{p} \} )}{P ( A , W ; \{ {W}_{p} \} )} P ( S ; \{ {W}_{p} \} ) , \qquad Eq . ( 1 )$$

where P(S; {Wₚ}) is the probability that speaker S is speaking, and P(A, W; {Wₚ}) is the probability of occurrence of audio feature A and word W. Eq. (1) follows from the two products P(S|A, W; {Wₚ})P(A, W; {Wₚ}) and P(A, W|S;{Wₚ})P(S; {Wₚ}) corresponding to the same entity (the probability of the union S ∪ A, W) written in two equivalent representations. Correspondingly, identification of speaker S* that maximizes the conditional probability P(S|A, W; {Wₚ}) can be performed by maximizing the product of the conditional probability P(A, W|S; {Wₚ}) and P(S; {Wₚ}):

$$\begin{matrix}{S}^{*} = {arg max}_{S} \{ P ( S \vert A , W ; \{ {W}_{p} \} ) \} \\ = {arg max}_{S} \{ \frac{P ( A , W \vert S ; \{ {W}_{p} \} )}{P ( A , W ; \{ {W}_{p} \} )} P ( S ; \{ {W}_{p} \} ) \} \\ = {arg max}_{S} \{ P ( A , W \vert S ; \{ {W}_{p} \} ) P ( S ; \{ {W}_{p} \} ) \} .\end{matrix} \qquad Eq . ( 2 )$$

Further simplification may be achieved by using a model in which the likelihoods of observing audio feature A and word W (for a given speaker S) are independent of each other. More specifically, the conditional probability P(A, W|S;{Wₚ}) may be approximated via the product of conditional probabilities,

$$P ( A , W \vert S ; \{ {W}_{p} \} ) = P ( A \vert S ; \{ {W}_{p} \} ) P ( W \vert S ; \{ {W}_{p} \} ) . \qquad Eq . ( 3 )$$

namely the conditional probability P(A|S;{Wₚ}) of observing audio feature A (irrespective of word W) for a given speaker S and the conditional probability P(W|S; {Wₚ}) of an utterance of word W (irrespective of audio feature A) given the same speaker S. This provides the following framework for predicting the most likely speaker by maximizing the product of three probabilities,

$$\begin{matrix}{S}^{*} = {arg max}_{S} \{ P ( A \vert S ; \{ {W}_{p} \} ) P ( W \vert S ; \{ {W}_{p} \} ) P ( S ; \{ {W}_{p} \} ) \} \\ = {arg max}_{S} \{ P ( A \vert S ; \{ {W}_{p} \} ) P ( S \vert W ; \{ {W}_{p} \} ) P ( W ; \{ {W}_{p} \} ) \} .\end{matrix} \qquad Eq . ( 4 )$$

In the embodiment illustrated in FIG. 3A, the conditional probability P(A|S;{Wₚ}) of observing audio feature A given prospective (hypothesized) speaker S may be determined by SD model 122. The conditional probability P(S|W;{Wₚ}) of speaker S uttering a known word W that follows the set of preceding words {Wₚ} and the probability P(W; {Wₚ}) that word W is uttered following the set of preceding words {Wₚ} may be determined by LM 124, using suitable prompts, e.g., as disclosed in more detail below.

Speaker search decoder 126 may perform a search across various prospective speakers S. For example, SD model 121 may have previously determined that M different speakers S₁ . . . S_{M} have spoken during a given speech episode (e.g., conversation, meeting, or any other structured or unstructured event). When a new audio feature A is received by multi-speaker speech recognition system 202, speaker search decoder 126 may perform search across M previously identified speakers S₁ . . . S_{M}. An iteration of the decoder may include selecting one of the speakers Sⱼ and providing the speaker label to SD model 122. SD model 122, having received the new audio feature A, may compute the conditional probability P(A|Sⱼ) that speaker Sⱼ has generated the audio feature A and return the computed conditional probability P(A|S) to speaker search decoder 126. Similarly, speaker search decoder 126 may receive—from LM 124—conditional probability P(W; {Wₚ}) that word W has been spoken after the set of words {Wₚ} and may further receive conditional probability P(Sⱼ|W;{Wₚ}) that the next word W was spoken by the speaker Sⱼ. Speaker search decoder 126 may then compute the total probability Pⱼ=P(A|Sⱼ)P(Sⱼ|W; {Wₚ})P(W; {Wₚ}) that characterizes the likelihood that speaker Sⱼ has produced audio feature A and may identify the target speaker S*as the speaker with the maximum likelihood Pⱼ.

In some embodiments, the Bayesian classifier algorithm disclosed above can be modified by introducing tunable parameters a and β that modify relative importance of different conditional probabilities, e.g.,

$${P}_{j} = P {{( A \vert {S}_{j} ) [ P ( {S}_{j} \vert W ; \{ {W}_{p} \} ) ]}^{β} [ P ( W ; \{ {W}_{p} \} ) ]}^{αβ} , \qquad Eq . ( 5 )$$

or equivalently in the logit form,

$$Eq . ( 6 )$$

$${L}_{j} ≡ Log {P}_{j} = Log [ P ( A \vert {S}_{j} ) ] + β Log [ P ( {S}_{j} \vert W ; \{ {W}_{p} \} ) {P}^{α} ( W ; \{ {W}_{p} \} ) ] ,$$

that can be used to perform speaker search. If all logit values are below a threshold value, audio feature A (and a respective spoken word W) may be assigned to a new speaker S_{M+1} (unless the number of speakers M in the speech episode is known beforehand, e.g., from metadata associated with the audio recording).

Even though the term P(W; {Wₚ}) in Eq. (5) and Eq. (6) is speaker-independent, maintaining it may be beneficial since for certain words (e.g., filler words), the probability P(Sⱼ|W;{Wₚ})≈1/M can be uniform across different speakers since distinguishing speakers by (speaker-non-specific) lexical content of the speech becomes difficult. Assigning relatively small probability P(W; {Wₚ}) to such words helps to handle such situations by giving more relative weight to the term P(A|Sⱼ) computed by SD model 122.

Parameter β may be used to control the relative weight given (with smaller values of β assigning less weight) to the output of LM 124 compared to the output of SD model 122. Parameter α controls the relative weight given to speaker predictions of LM 124 compared to the next-word predictions of LM 124.

SD model 122 may be any model trained to output conditional probability P(A|Sⱼ). SD model 122 may be a neural network model, e.g., a transformer model, a convolutional neural network (CNN) model, a conformer model (a combination of a transformer model and a CNN), a long short-term memory (LSTM) model, a recurrent neural network model, and or the like. In one embodiment, SD model 122 may process individual frames aₜ (associated with various timestamps t) that collectively make audio feature A=a₁ . . . a_{T}. SD model 122 may generate logit values p(Sⱼ|aₜ) characterizing a likelihood that speaker Sⱼ is associated with frame aₜ and then sum over all logit values of the audio feature,

$$P ( A \vert {S}_{j} ) = \frac{1}{T} \frac{{\sum }_{t = 1}^{T} p ( {S}_{j} \vert {a}_{t} )}{{\sum }_{k = 1}^{M} P ( A \vert {S}_{k} )} , \qquad Eq . ( 7 )$$

such that the floating-point probabilities P(A|Sₖ) add up to one.

In some embodiments, LM 124 may be an N-gram language model, a large language model, or some other language model. Large language models may have a transformer-based architecture and may deploy self-attention blocks, cross-attention blocks, positional encodings, and/or other elements of neural network architecture. Large language models may have hundreds of millions of (or more, e.g., one to several billions or even more) parameters that are learned during training. Training of language models may include next word prediction techniques, missing word predictions techniques, intent detection techniques, sentiment detection techniques, sentence association techniques, and/or the like. Training of language models may further include training with specialized (e.g., subject-matter specific) corpus of texts, and/or other techniques. LM 124 may be trained to predict probability P(W; {Wₚ}) that word W followed a series of one or more preceding words {Wₚ} and further trained to predict conditional probability P(Sⱼ|W;{Wₚ}) that speaker Sⱼ has uttered word W after the one or more preceding words {Wₚ}.

Multi-speaker speech recognition system 202 may use LM prompts 322 to generate requests to LM 124 to identify the probabilities P(W; {Wₚ}) and/or P(Sⱼ|W; {Wₚ}). In one illustrative example, speaker A and speaker B may be engaged in the following conversation:
Speaker A: How are you?
Speaker B: Good, you?
Speaker A: Great! Nice weekend?
Speaker B: Yes!

To identify probabilities P(W; {Wₚ}), for the word W=(weekend) to be spoken, LM prompts 322 may generate a next-word prompt 324 that includes previously identified words {Wₚ}(e.g., taken from words 320 identified by ASR 120) and then ask LL 124 about the most likely next word, e.g.,
[Speaker A]: How are you?
[Speaker B]: Good, you?
[Speaker A]: Great! Nice . . .
[Question]: What is the most likely next word?

In addition to the most likely word (“weekend”) outputted by LM 124, multi-speaker speech recognition system 202 may also access logits, e.g., logarithms (or other suitable representations) of probabilities P(W; {Wₚ}), generated by LM 124 (e.g., by the penultimate layer of neurons of LM 124) for multiple words of the vocabulary of LM 124, e.g., words “weekend,” “haircut,” “weather,” “vacation,” “trip,” and so on. The obtained probabilities 325 (logits) may then be provided to speaker search decoder 126.

To identify probabilities P(Sⱼ|W;{Wₚ}), for the word W to be spoken by various speakers (e.g., Speaker A, Speaker B, or some new speaker), LM prompts 322 may generate a speaker prompt 326 that includes word W and previously identified words {Wₚ} and then ask LL 124 about the most likely speaker, e.g.,
[Speaker A]: How are you?
[Speaker B]: Good, you?
[Speaker A]: Great! Nice
[Question]: The next word is (weekend). Who spoke (weekend)?

In addition to the most likely speaker (Speaker A) outputted by LM 124, multi-speaker speech recognition system 202 may also access logits, e.g., logarithms (or other suitable representations) of probabilities P(Sⱼ|W; {Wₚ}) generated by LM 124 (e.g., by the penultimate layer of neurons of LM 124) for various speakers, e.g., Speaker A, Speaker B, or a new Speaker C. The obtained probabilities 327 (logits) may then be provided to speaker search decoder 126.

FIG. 3B illustrates operations of automatic speech recognition 120 component of multi-speaker speech recognition system 202, according to at least one embodiment. ASR 120 may identify the most likely spoken word W*, which is then added to words 320 (e.g., as part of the transcription of the speech episode).

In some embodiments, ASR 120 uses a Bayesian-like classifier that predicts a conditional probability P(W|A; {Wₚ}) that an utterance of a particular word W is captured by audio feature A following a series of one or more preceding words {Wₚ}. More specifically, the conditional probability P(W|A; {Wₚ}) may be represented using the conditional probability P(A|W; {Wₚ}) of the audio feature A capturing word W (“probability of A given W”),

$$P ( W \vert A ; \{ {W}_{p} \} ) = \frac{P ( A \vert W ; \{ {W}_{p} \} )}{P ( A ; \{ {W}_{p} \} )} P ( W ; \{ {W}_{p} \} ) , \qquad Eq . ( 8 )$$

where P(W; {Wₚ}) is the probability of word W being uttered, and P(A; {Wₚ}) is the probability of occurrence of the audio feature A. Correspondingly, identification of word W* that maximizes the conditional probability P(W|A; {Wₚ}) may be performed by maximizing the product of the conditional probability P(A|W;{Wₚ}) and P(W;{Wₚ}):

$$\begin{matrix}{S}^{*} = {arg max}_{W} \{ P ( W \vert A ; \{ {W}_{p} \} ) \} \\ = {arg max}_{W} \{ \frac{P ( A \vert W ; \{ {W}_{p} \} )}{P ( A ; \{ {W}_{p} \} )} P ( W ; \{ {W}_{p} \} ) \} \\ = {arg max}_{W} \{ P ( A \vert W ; \{ {W}_{p} \} ) P ( W ; \{ {W}_{p} \} ) \} .\end{matrix} \qquad Eq . ( 9 )$$

In the embodiment illustrated in FIG. 3B, the conditional probability P(A|W; {Wₚ}) of observing audio feature A given uttered word W may be determined by SR acoustic model 340. The probability P(W; {Wₚ}) of word W being uttered may be determined by language model 350, which may be the same as or different from LM 124.

Word search decoder 360 may perform a search across various possible words W. An iteration of the word search decoder 360 may include selecting one of vocabulary words W and providing the selected word to SR acoustic model 340. SR acoustic model 340, having received the new audio feature A, can compute the conditional probability P(A|W) 342 that word W is captured by the audio feature A and may return the computed conditional probability P(A|W) to word search decoder 360. Similarly, word search decoder 360 may receive—from language model 350-a probability 352 that word W has been spoken. In some embodiments, probability 352 may be the probability P(W; {W}) computed by language model 350 in view of the previously spoken set of words {Wₚ}. In some embodiments, probability 352 may be the probability P(W) of the word determined independently of the previously spoken words, e.g., based on the general likelihood of occurrence of the word W in the spoken language. The word search decoder 360 may then compute the total likelihood P(A|W; {Wₚ})P(W; {Wₚ}) or P(A|W; {Wₚ})P(W) that characterizes the likelihood that word W was captured by audio feature A and identify the most likely word W*as the word with the highest likelihood.

Although, for simplicity and conciseness, FIG. 3A and FIG. 3B illustrate that the same audio features 310 are processed by SD model 340 SR and acoustic model 340, in other embodiments, the audio features (embeddings) processed by the two models may be different, e.g., may have different dimensionality, types (e.g., integer vs. floating point values), and may be generated using different frame-to-embedding converters.

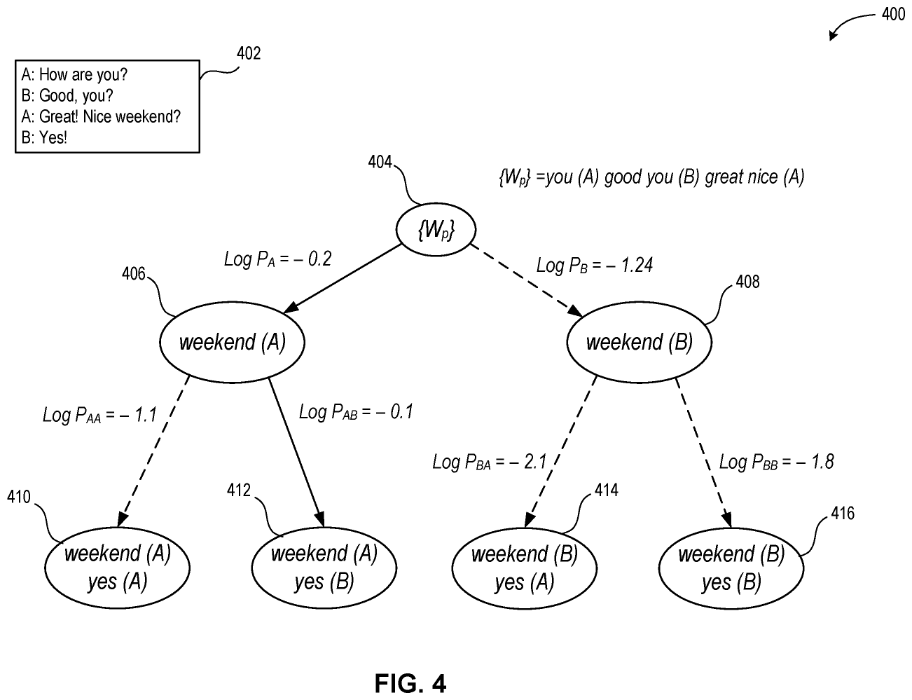

FIG. 4 illustrates example operations 400 of speaker search decoder 126 deployed as part of multi-speaker speech recognition system 202 of FIG. 3A, according to at least one embodiment. In some embodiments, speaker search decoder 126 may implement a breadth-first search or a depth-first search. In some embodiments, speaker search decoder 126 may implement a beam search, in which a predetermined number of candidate paths are kept at each iteration of the search. For example, in a beam search performed in the context of the conversation 402,
[Speaker A]: How are you?
[Speaker B]: Good, you?
[Speaker A]: Great! Nice weekend?
[Speaker B]: Yes!
   the words “you” (Speaker A) “good you” (Speaker B) “great nice” (Speaker A) may constitute words {Wₚ}, for which the corresponding speakers have been determined, and that represents a root node 404 of the beam search. At the first level, two nodes associated with the word “weekend” correspond to possible speaker A (node 406) and possible speaker B (node 408). Individual nodes of the first level are associated with corresponding likelihoods, e.g., logits Log P characterizing the corresponding probabilities, that the word (“weekend”) of the first level was uttered by the respective speaker. For example, Log P_{A}=−0.2 may be the logarithm of the probability P_{A} (determined by LM 124 as described in conjunction with FIG. 3A) that the word of the first level was uttered by speaker A. At the second level, two nodes associated with the word “yes” corresponding to possible speaker A (node 410) and possible speaker B (node 412) originate from node 406 and two additional nodes associated with the word “yes” corresponding to possible speaker A (node 414) and possible speaker B (node 416) originate from node 408. Individual nodes of the second level are also associated with likelihoods, e.g., Log P_{BA}-2.1 indicates the logarithm of the probability P_{BA} (also determined by LM 124 in FIG. 3A) that the word (“yes”) of the second level was uttered by speaker A with the word (“weekend”) of the first level uttered by speaker B. Based on the computed likelihoods, the speaker search decoder may determine that the most probable path (indicated with solid arrows, having the largest logit values at each level) through the graph of the nodes includes node 406 and node 412 indicating that the word “weekend” of the first level was spoken by Speaker A and node 412 indicating that the word “yes” of the second level was spoken by Speaker B.

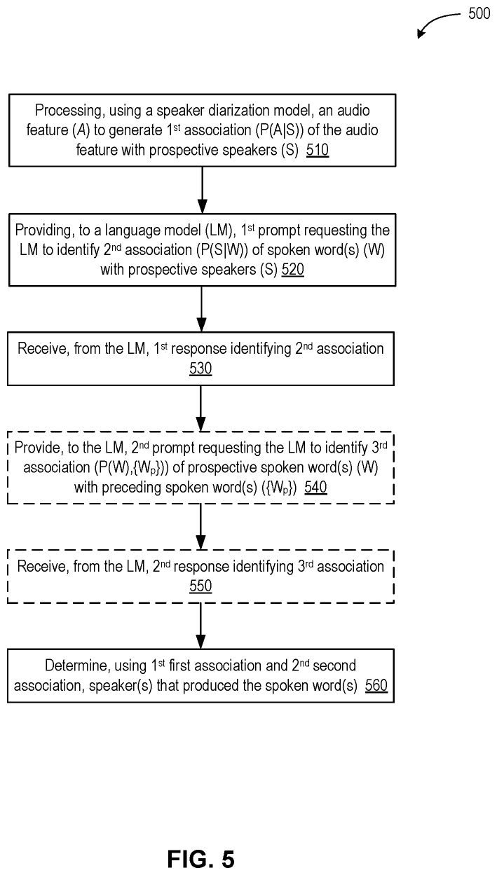

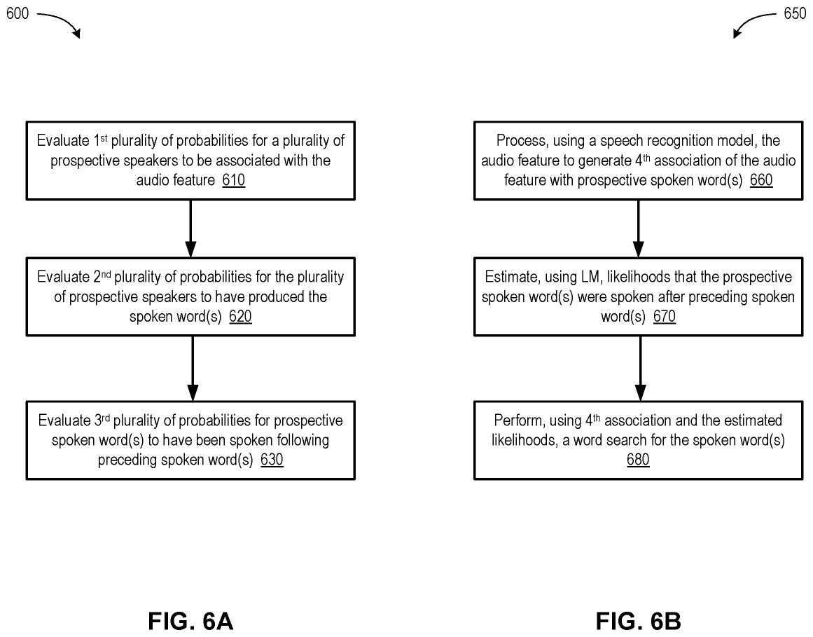

FIG. 5, FIG. 6A, and FIG. 6B are flow diagrams of respective methods 500 and 600 that facilitate efficient multi-speaker speech recognition, according to at least one embodiment. Methods 500, 600, and 650 may be performed using one or more processing units (e.g., CPUs, GPUs, accelerators, PPUs, DPUs, etc.), which may include (or communicate with) one or more memory devices. In at least one embodiment, methods 500, 600, and 650 may be performed using processing units of audio processing server 102. In at least one embodiment, processing units performing any of methods 500, 600, and 650 may be executing instructions stored on a non-transient computer-readable storage media. In at least one embodiment, any of methods 500, 600, and 650 may be performed using multiple processing threads (e.g., CPU threads and/or GPU threads), individual threads executing one or more individual functions, routines, subroutines, or operations of the methods. In at least one embodiment, processing threads implementing any of methods 500, 600, and 650 may be synchronized (e.g., using semaphores, critical sections, and/or other thread synchronization mechanisms). Alternatively, processing threads implementing any of methods 500, 600, and 650 may be executed asynchronously with respect to each other. Various operations of any of methods 500, 600, and 650 may be performed in a different order compared with the order shown in FIG. 5, FIG. 6A, and FIG. 6B. Some operations of any of methods 500, 600, and 650 may be performed concurrently with other operations. In at least one embodiment, one or more operations shown in FIG. 5, FIG. 6A, and FIG. 6B may not always be performed.

Methods 500, 600, and 650 may be performed in the context of speech identification, speech verification, and/or speech diarization. Methods 500, 600, and 650 may involve speech utterances produced by people in any possible context, e.g., a conversation, a public speech, a public event, a business meeting, a conference, a street encounter, an interaction in a game, an interaction with a chat bot or digital avatar, an interaction with an in-vehicle infotainment system, and/or the like.

FIG. 5 is a flow diagram of an example method 500 of efficient multi-speaker speech recognition assisted by one or more language models, according to at least one embodiment. One or more operations of method 500 may be performed by multi-speaker speech recognition system 202 of FIG. 2. Operations of method 500 may be performed using one or more audio features (e.g., audio features 310 of FIG. 3A and FIG. 3B) representative of one or more spoken words. In some embodiments, the audio features may be digital embeddings obtained by converting a suitable representation of a speech recording into an embedding space. In one example, the audio feature is obtained using one or more audio spectrograms of a portion of an audio recording capturing the one or more spoken words.

At block 510, one or more processing units executing method 500 may process, using a speaker diarization model (e.g., SD 122 in FIG. 3A), an audio feature to generate a first association of the audio feature with one or more prospective speakers. In some embodiments, the first association may include one or more probabilities P(A|Sⱼ). An individual probability of the one or more probabilities may characterize a likelihood that a respective speaker Sⱼ of the one or more prospective speakers is associated with the audio feature A.

At block 520, the one or more processing units may provide, to a language model (e.g., LM 124 in FIG. 3A), a first prompt (e.g., next word prompt 324 in FIG. 3A) requesting the LM to identify a second association of the one or more spoken words with the one or more prospective speakers. In some embodiments, the second association may include one or more probabilities P(Sⱼ|W). An individual probability of the one or more probabilities may characterize a likelihood that a respective speaker Sⱼ of the one or more prospective speakers has produced the one or more spoken words W. At block 530, method 500 may continue with receiving, from the LM, a first response identifying the second association of the one or more spoken words with the one or more prospective speakers.

In some embodiments, method 500 may include operations of dashed blocks 540-550 of FIG. 5. More specifically, at block 540, the one or more processing units performing method 500 may provide, to the LM, a second prompt (e.g., speaker prompt 326 in FIG. 3A) requesting the LM to identify a third association of one or more prospective spoken words with one or more preceding spoken words. In some embodiments, the third association may include one or more probabilities P(W|{Wₚ}). An individual probability of the one or more probabilities may characterize a likelihood that a prospective (hypothesized) spoken word W of the one or more prospective spoken words was produced following the one or more preceding spoken words {Wₚ}. At block 550, method 500 may include receiving, from the LM, a second response identifying the third association of the one or more prospective spoken words with the one or more preceding (known, already determined) spoken words.

At block 560, method 500 may include determining, using the first association and the second association, one or more speakers S that produced the one or more spoken words W. In some embodiments determining that the one or more speakers produced the one or more spoken words may include using the first association (e.g., probabilities P(A|Sⱼ) and/or the like), using the second association (e.g., probabilities P(Sⱼ|W) and/or the like) and may also include using the third association (e.g., P(W|{Wₚ}) and/or the like).

FIG. 6A is a flow diagram of an example method 600 of performing a speaker search in the context of multi-speaker speech recognition assisted by one or more language models, according to at least one embodiment. One or more operations of method 600 may be performed by multi-speaker speech recognition system 202 of FIG. 2, e.g., as illustrated in FIG. 3A. In some embodiments, the speaker search may be performed, using at least the first association and the second association. In some embodiments, the speaker search may include a beam search. In other embodiments, the speaker search may include a depth-first search and/or a breadth-first search.

At block 610, one or more processing units executing method 600 may evaluate a first plurality of probabilities (e.g., P(A|Sⱼ) and/or the like) for a plurality of prospective speakers Sⱼ to be associated with the audio feature A. At block 620, one or more processing units executing method 600 may evaluate a second plurality of probabilities (e.g., P(Sⱼ|W) and/or the like) for the plurality of prospective speakers Sⱼ to have produced the one or more spoken words W. In some embodiments, the first plurality of probabilities and the second plurality of probabilities may be evaluated using a Bayes classifier (e.g., as disclosed in conjunction with FIG. 3A). In some embodiments, the first plurality of probabilities and the second plurality of probabilities may be evaluated using a classifier that includes one or more learned parameters (e.g., exponents α and β, as disclosed in conjunction with FIG. 3A) determined during training of the classifier.

In some embodiments, performing the speaker search may further include evaluating a third plurality of probabilities (e.g., P(W|{Wₚ}) and/or the like) for one or more prospective spoken words W to have been spoken following one or more preceding spoken words {Wₚ}.

FIG. 6B is a flow diagram of an example method 650 of identifying spoken words in the context of multi-speaker speech recognition assisted by one or more language models, according to at least one embodiment. One or more operations of method 650 may be performed by ASR 120 component of multi-speaker speech recognition system 202 of FIG. 2, e.g., as illustrated in FIG. 3B. In some embodiments, method 650 may include processing, using a speech recognition model (e.g., SR acoustic model 340 in FIG. 3B), an audio feature to generate a fourth association (e.g., P(A|W) and/or the like) of the audio feature A with one or more prospective spoken words W. At block 670, method 650 may continue with estimating, using at least one of the LM (e.g., LM 124) or an additional LM (e.g., LM 350 in FIG. 3B), likelihoods (e.g., P(W|{Wₚ}) and/or the like) that the one or more prospective spoken words W were spoken after one or more preceding spoken words {Wₚ}. At block 680, method 600 may include performing, using at least the fourth association (e.g., P(A|W) and/or the like) and the estimated likelihoods (e.g., P(W|{Wₚ}) and/or the like), a word search for the one or more spoken words (e.g., as disclosed in conjunction with FIG. 3B).

The systems and methods described herein may be used for a variety of purposes, by way of example and without limitation, for performing one or more operations with respect to machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an in-vehicle infotainment system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Inference and Training Logic

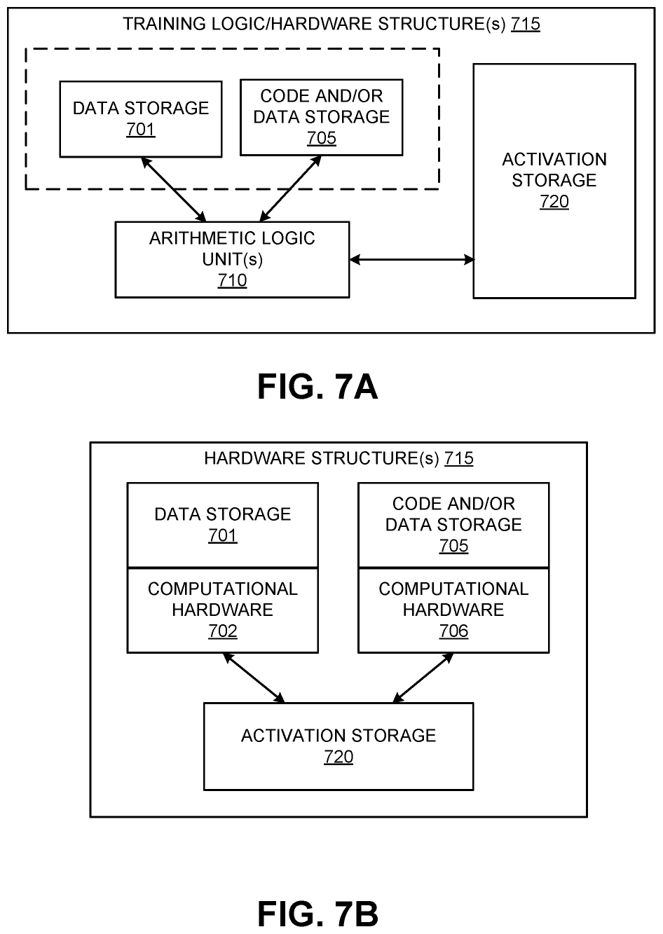

FIG. 7A illustrates inference and/or training logic 715 used to perform inferencing and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

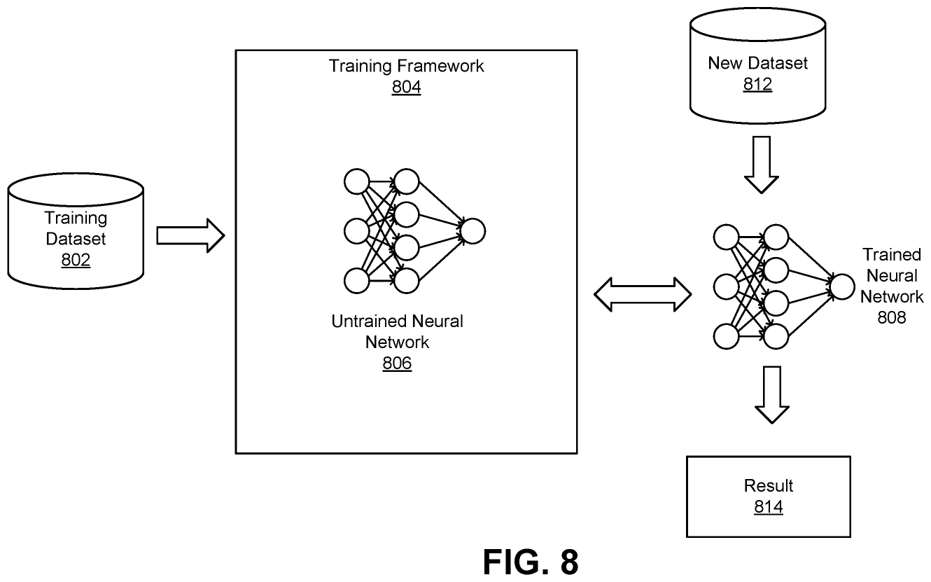

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, whereas untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

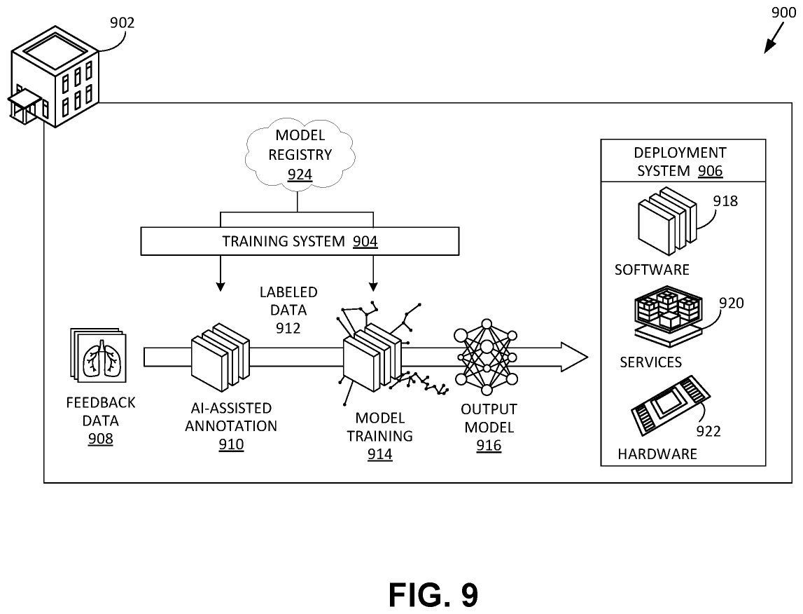

With reference to FIG. 9, FIG. 9 is an example data flow diagram for a process 900 of generating and deploying a processing and inferencing pipeline, according to at least one embodiment. In at least one embodiment, process 900 may be deployed to perform game name recognition analysis and inferencing on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in advanced processing and inferencing pipelines may use machine learning models or other AI to perform one or more processing steps. In at least one embodiment, machine learning models may be trained at facility 902 using feedback data 908 (such as imaging data) stored at facility 902 or feedback data 908 from another facility or facilities, or a combination thereof. In at least one embodiment, training system 904 may be used to provide applications, services, and/or other resources for generating working, deployable machine learning models for deployment system 906.

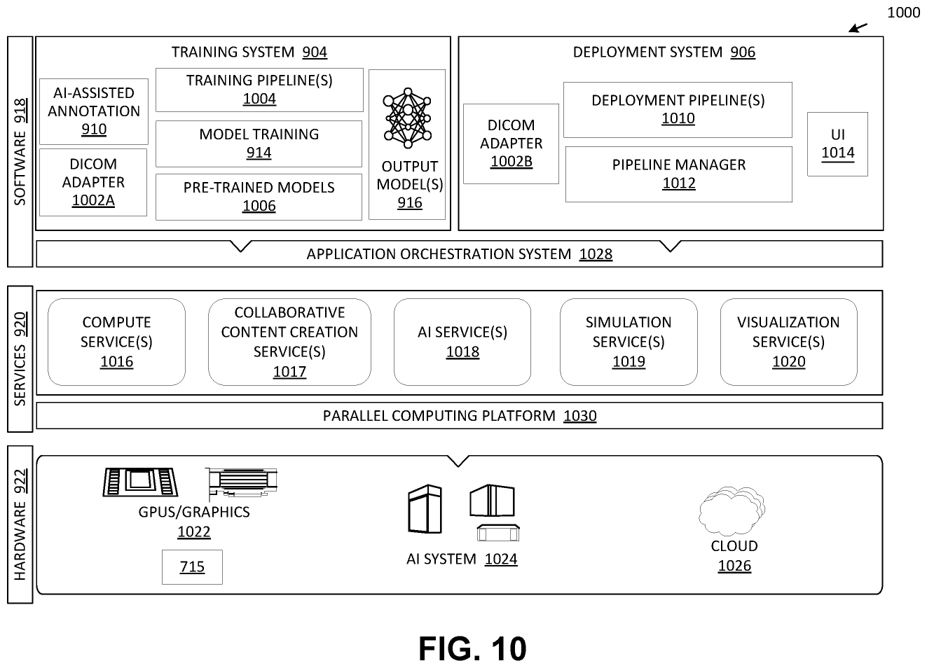

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model, or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIGS. 9-10. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities that are remotely located). In at least one embodiment, machine learning models may have been trained on imaging data from one location, two locations, or any number of locations. In at least one embodiment, when being trained on imaging data, which may be a form of feedback data 908, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914—e.g., AI-assisted annotations 910, labeled data 912, or a combination thereof—may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inferencing pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., system 1000 of FIG. 10). In at least one embodiment, once validated by system 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, collaborative content creation services, simulation services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 918 implementing advanced processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, simulation, and visual computing, as non-limiting examples. In at least one embodiment, at least some of the computing environment of deployment system 906 and/or training system 904 may be executed in a datacenter or one or more supercomputers or high performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example system 1000 for generating and deploying a deployment pipeline, according to at least one embodiment. In at least one embodiment, system 1000 may be used to implement process 900 of FIG. 9 and/or other processes including advanced processing and inferencing pipelines. In at least one embodiment, system 1000 may include training system 904 and deployment system 906. In at least one embodiment, training system 904 and deployment system 906 may be implemented using software 918, services 920, and/or hardware 922, as described herein.

In at least one embodiment, system 1000 (e.g., training system 904 and/or deployment system 906) may implemented in a cloud computing environment (e.g., using cloud 1026). In at least one embodiment, system 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1000, may be restricted to a set of public internet service providers (ISPs) that have been vetted or authorized for interaction.

In at least one embodiment, various components of system 1000 may communicate between and among one another using any of a variety of different network types, including but not limited to local area networks (LANs) and/or wide area networks (WANs) via wired and/or wireless communication protocols. In at least one embodiment, communication between facilities and components of system 1000 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904, and may be implemented by deployment system 906.

In at least one embodiment, output model(s) 916 and/or pre-trained model(s) 1006 may include any types of machine learning models depending on embodiment. In at least one embodiment, and without limitation, machine learning models used by system 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of, AI-assisted annotation included in training pipelines 1004. In at least one embodiment, system 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types), including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface (UI) 1014 (e.g., a graphical user interface, a web interface, etc.) that may be used to select applications for inclusion in deployment pipeline(s) 1010, arrange applications, modify or change applications or parameters or constructs thereof, use and intera with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904. In at least one embodiment, training system 904 and deployment system 906 may include DICOM adapters 1002A and 1002B.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 920 leveraged and shared by applications or containers in deployment system 906 may include compute services 1016, collaborative content creation services 1017, AI services 1018, simulation services 1019, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA®) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inferencing services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inferencing tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inferencing tasks of AI services 1018.

In at least one embodiment, shared storage may be mounted to AI services 1018 within system 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing or other light transport simulation techniques, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA® and/or QUADRO® GPUs) may include any number of GPUs that may be used for executing processing tasks of compute services 1016, collaborative content creation services 1017, AI services 1018, simulation services 1019, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inferencing (e.g., to execute machine learning models). In at least one embodiment, cloud 1026, AI system 1024, and/or other components of system 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inferencing—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inferencing, deep learning, machine learning, and/or other artificial intelligence tasks. In at least one embodiment, AI system 1024 (e.g., NVIDIA's DGX™) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of system 1000.

In at least one embodiment, cloud 1026 may include a GPU-accelerated infrastructure (e.g., NVIDIA's NGC™) that may provide a GPU-optimized platform for executing processing tasks of system 1000. In at least one embodiment, cloud 1026 may include an AI system(s) 1024 for performing one or more of AI-based tasks of system 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of system 1000, including compute services 1016, AI services 1018, and/or visualization services 1020, as described herein. In at least one embodiment, cloud 1026 may perform small and large batch inference (e.g., executing NVIDIA's TensorRT™), provide an accelerated parallel computing API and platform 1030 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1000.

In at least one embodiment, in an effort to preserve patient confidentiality (e.g., where patient data or records are to be used off-premises), cloud 1026 may include a registry, such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
processing, using a speaker diarization model, an audio feature to generate a first association of the audio feature with one or more prospective speakers, the audio feature being representative of one or more spoken words;
providing, to a language model (LM), a first prompt requesting the LM to identify a second association of the one or more spoken words with the one or more prospective speakers;
receiving, from the LM, a first response identifying the second association of the one or more spoken words with the one or more prospective speakers; and
determining, using the first association and the second association, one or more speakers that produced the one or more spoken words.

2. The method of claim 1, wherein the first association comprises:
one or more probabilities, wherein an individual probability of the one or more probabilities characterizes a likelihood that a respective speaker of the one or more prospective speakers is associated with the audio feature.

3. The method of claim 1, wherein the second association comprises:
one or more probabilities, wherein an individual probability of the one or more probabilities characterizes a likelihood that a respective speaker of the one or more prospective speakers has produced the one or more spoken words.

4. The method of claim 1, further comprising:
providing, to the LM, a second prompt requesting the LM to identify a third association of one or more prospective spoken words with one or more preceding spoken words; and
receiving, from the LM, a second response identifying the third association of the one or more prospective spoken words with the one or more preceding spoken words; and
wherein determining that the one or more speakers produced the one or more spoken words further comprises using the third association.

5. The method of claim 4, wherein the third association comprises:
one or more probabilities, wherein an individual probability of the one or more probabilities characterizes a likelihood that a prospective spoken word of the one or more prospective spoken words was produced following the one or more preceding spoken words.

6. The method of claim 1, wherein determining the one or more speakers that produced the one or more spoken words comprises:
performing, using at least the first association and the second association, a speaker search, wherein performing the speaker search comprises:
evaluating a first plurality of probabilities for a plurality of prospective speakers to be associated with the audio feature, and
evaluating a second plurality of probabilities for the plurality of prospective speakers to have produced the one or more spoken words.

7. The method of claim 6, wherein performing the speaker search further comprises:
evaluating a third plurality of probabilities for one or more prospective spoken words to have been spoken following one or more preceding spoken words.

8. The method of claim 6, wherein the speaker search comprises a beam search.

9. The method of claim 6, wherein the first plurality of probabilities and the second plurality of probabilities are evaluated using a Bayes classifier.

10. The method of claim 6, wherein the first plurality of probabilities and the second plurality of probabilities are evaluated using a classifier that comprises one or more parameters determined during training of the classifier.

11. The method of claim 1, wherein the one or more spoken words are determined by:
processing, using a speech recognition model, the audio feature to generate a fourth association of the audio feature with one or more prospective spoken words.

12. The method of claim 11, wherein the one or more spoken words are further determined by:
estimating, using at least one of the LM or an additional LM, likelihoods that the one or more prospective spoken words were spoken after one or more preceding spoken words.

13. The method of claim 12, wherein the one or more spoken words are further determined by:
performing, using at least the fourth association and the estimated likelihoods, a word search for the one or more spoken words.

14. The method of claim 1, wherein the audio feature is obtained using one or more audio spectrograms of a portion of an audio recording capturing the one or more spoken words.

15. A system comprising:
one or more processing units to:
process, using a machine learning model, an audio feature to generate a first association of the audio feature with one or more prospective speakers, the audio feature being representative of one or more spoken words;
provide, to a language model (LM), a first prompt requesting the LM to identify a second association of the one or more spoken words with the one or more prospective speakers;
receive, from the LM, a first response identifying the second association of the one or more spoken words with the one or more prospective speakers; and
determine, using the first association and the second association, one or more speakers that produced the one or more spoken words.

16. The system of claim 15, wherein the one or more processing units are further to:
provide, to the LM, a second prompt requesting the LM to identify a third association of one or more prospective spoken words with one or more preceding spoken words; and
receive, from the LM, a second response identifying the third association of the one or more prospective spoken words with the one or more preceding spoken words; and
wherein to determine that the one or more speakers produced the one or more spoken words, the one or more processing units are further to use the third association.

17. The system of claim 15, wherein to determine the one or more speakers that produced the one or more spoken words, the one or more processing units are to:
perform, using at least the first association and the second association, a speaker search, wherein to perform the speaker search, the one or more processing units are to:
evaluate a first plurality of probabilities for a plurality of prospective speakers to be associated with the audio feature, and
evaluate a second plurality of probabilities for the plurality of prospective speakers to have produced the one or more spoken words.

18. The system of claim 17, wherein to perform the speaker search, the one or more processing units are further to:
evaluate a third plurality of probabilities for one or more prospective spoken words to have been spoken following one or more preceding spoken words.

19. The system of claim 17, wherein the first plurality of probabilities and the second plurality of probabilities are evaluated using a classifier that comprises one or more parameters determined during training of the classifier.

20. The system of claim 15, wherein the system is comprised in at least one of:
an in-vehicle infotainment system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one of virtual reality content, mixed reality content, or augmented reality content;
a system implemented using a robot;
a system for performing one or more conversational AI operations;
a system implementing one or more large language models (LLMs);
a system implementing one or more language models;
a system for performing conversational AI operations;
a system for generating synthetic data;
a system incorporating one or more virtual machines (VMs);
a system implemented at least partially in a data center; or
a system implemented at least partially using cloud computing resources.

21. A processing device to:
process, using a machine learning model (MLM), an audio feature to generate a first association of the audio feature with one or more prospective speakers, the audio feature being representative of one or more spoken words;
generate, using a language model (LM) and based at least on a request to the LM to identify a second association of the one or more spoken words with the one or more prospective speakers, a first response identifying the second association of the one or more spoken words with the one or more prospective speakers; and
determine, using the first association and the second association, one or more speakers that produced the one or more spoken words.
